(19) United States
(12) Patent Application Publication
(10) Pub. No.: US 2008/0166941 A1
(43) Pub. Date: Jul. 10, 2008

(54) METHOD FOR FABRICATING SPACERS

(75) Inventor: Tsung-Chin Chen, Taipei (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, omitted

(73) Assignee: AU OPTRONICS CORPORATION, Hsinchu (TW)

(21) Appl. No.: 11/757,412

(22) Filed: Jun. 4, 2007

(30) Foreign Application Priority Data
Jan. 3, 2007 (TW) 96100226

(51) Int. Cl. H01J 9/00

(52) U.S. Cl. 445/58

(57) ABSTRACT

A method for fabricating spacers is provided. The spacers are suitable to be installed in a liquid crystal display (LCD) panel. Firstly, a substrate having a display area and a non-display area is provided. Afterwards, a number of spacer materials are sprayed over the substrate. Then, a light beam is employed to irradiate the spacer materials through a mask shielding the display area in order to bake the spacer materials. Subsequently, spacer materials which are not baked are removed. Moreover, in another method for fabricating spacers of the present invention, a number of spacer materials are sprayed over a part of the substrate through a mask. Then, the spacer materials are baked.

### CROSS-REFERENCE TO RELATED APPLICATION

This application claims the priority benefit of Taiwan application serial no. 96100226, filed on Jan. 3, 2007. All disclosure of the Taiwan application is incorporated herein by reference.

### BACKGROUND OF THE INVENTION

1. Field of the Invention

The present invention relates to a method for fabricating a liquid crystal display. More particularly, the present invention relates to a method for fabricating spacers.

2. Description of Related Art

Cathode ray tube (CRT) displays are gradually replaced by flat panel displays due to the trends towards light, thin, short, and small displays. Among various flat panel displays, liquid crystal displays (LCDs), having superior characteristics such as quick response speed, high luminance, high contrast, and wide viewing angle, has become mainstream products in the market. Generally speaking, an LCD is constituted of an LCD panel and a backlight module, wherein the LCD panel includes a color filter substrate, an active device array substrate, and a liquid crystal layer disposed therebetween. The backlight module provides a surface light source for the LCD panel.

A large number of spacers is usually disposed in the liquid crystal layer, i.e. between the color filter substrate and the active device array substrate. The spacers enable cell gaps of the LCD panel to be the same, such that the liquid crystal layer has a uniform thickness.

FIG. 1 is a flow chart of the processes of a conventional method for fabricating the spacers. The conventional method for fabricating the spacer includes firstly providing a substrate (Step 10), and then spraying spacer materials (Step 12). The method for spraying the spacer materials includes a spacer distributing process, in which a spacer distributing apparatus is used to spray the spacers over each region of the substrate. Then, in Step 14, the excess spacer materials are removed. In Step 14, the stacked and cohered spacer materials are removed by a remover.

Subsequently, in Step 16, the spacer materials are checked. If the distribution of the spacer materials is qualified, Step 18 is processed to bake the spacer materials for adhering to the substrate. If the distribution of the spacer materials is unqualified, i.e., problems including cohesion, non-uniform distribution, or impurity occur, proceed to Step 20 to remove all of the spacer materials. Afterwards, Step 12, 14, 16, and 18 are repeated sequentially.

The aforementioned method for fabricating the spacers has the following disadvantages. The spacer materials are sprayed over all the regions of the substrate, including a display area and a non-display area. As a result, if the formed spacers in the display have poor quality, defects caused by the poor quality are visible.

Currently, the spacer materials used in this field are mostly ball type spacer materials. However, the ball type spacer materials commonly have the following disadvantages. For example, (1) the cohesion of the ball type spacer materials easily occurs. (2) Since the ball type spacer materials have the light leakage problem, the LCD adopting the ball type spacer materials has poor contrast. (3) In the course of delivering the LCD panel or a reliability test, the ball type spacer materials are moved slightly, thus scraping the color filter substrate and eventually causing bright spots.

Another commonly used type of spacers is photo spacers (PS) fabricated through a lithographic process. The photo spacers can alleviate the disadvantages of the aforementioned ball type spacers, and also enhance the transmittance and impact resistance. Therefore, the photo spacers are increasingly popular. However, the photo spacers have a high hardness, so the compression ratio and the recovery ratio of the photo spacers are not as high as the ball type spacers. Therefore, if the size of the photo spacers is not well controlled, the filling amount of the liquid crystal is difficult to be controlled. In addition, as a lithographic process is required, the cost of the photo spacers is high. Furthermore, the large number of photo spacers cannot have uniform height through the current process.

SEKISUI CHEMICAL Co., Ltd. provides a method for fabricating spacers. The method includes preparing a suspension by dissolving wet spacer materials into a solvent, dropping the suspension on a non-display area by inkjet technology, and volatilizing the solvent, thereby forming the spacers. However, such spacers cannot be put into use until new processes and relevant equipments are developed. Furthermore, since the solvent must be used in this method, the material for the spacers is greatly limited.

### SUMMARY OF THE INVENTION

The present invention is directed to a method for fabricating spacers, so as to solve the problems of cohesion, light leakage, and bright spots of the ball type spacers.

The present invention is further directed to a method for fabricating spacers, thereby reducing the manufacturing cost of the spacers.

As embodied and broadly described herein, the present invention provides a method for fabricating spacers which are suitable to be installed in an LCD panel. The fabricating method includes firstly providing a substrate having a display area and a non-display area. Thereafter, a number of spacer materials is sprayed over the substrate. Subsequently, a light beam is employed to irradiate the spacer materials on a part of the substrate through a mask shielding the display area in order to bake the spacer materials. Then, the spacer materials which are not baked are removed.

In an embodiment of the present invention, the mask shields a part of the non-display area.

In an embodiment of the present invention, the light beam is UV light, infrared ray, or laser beam.

In an embodiment of the present invention, the position to be irradiated by the light beam is precisely controlled to remove the mask.

In an embodiment of the present invention, a temperature of baking the spacer materials on a part of the substrate is in the range of 120° C.-180° C.

In an embodiment of the present invention, a temperature of baking the spacer materials on a part of the substrate is preferably in the range of 140° C.-160° C.

As embodied and broadly described herein, the present invention further provides a method for fabricating spacers which are suitable to be installed in an LCD panel. The fabricating method includes firstly providing a substrate having a display area and a non-display area; spraying a number of spacer materials over a part of the substrate through a mask; and baking the spacer materials.

In an embodiment of the present invention, all of the mask and the spacer materials carry positive electric charges or negative electric charges.

In an embodiment of the present invention, the mask shields the display area.

In an embodiment of the present invention, the mask shields a part of the non-display area.

In an embodiment of the present invention, a temperature of baking the spacer materials is in the range of 120° C.-180° C.

In an embodiment of the present invention, a temperature of baking the spacer materials is preferably in the range of 140° C.-160° C.

According to the present invention, since the positions where the spacers are formed are limited in the non-display area, the problems of cohesion and light leakage of the spacers are reduced. Furthermore, since the spacers are fabricated by baking the spacer materials, the formed spacers stick onto the substrate, and thereby the spacers will not move and scrape the substrate. In addition, as compared with the process of fabricating the photo spacers, the method for fabricating spacers provided by the present invention has low cost.

In order to the make aforementioned and other objects, features and advantages of the present invention comprehensible, preferred embodiments accompanied with figures are described in detail below.

It is to be understood that both the foregoing general description and the following detailed description are exemplary, and are intended to provide further explanation of the invention as claimed.

### BRIEF DESCRIPTION OF THE DRAWINGS

FIG. 1 is a flow chart of processes of the conventional method for fabricating spacers.

FIG. 2 is a flow chart of the processes of the method for fabricating spacers according to the first embodiment of the present invention.

FIGS. 3A-3C are flow charts of the processes of the method for fabricating spacers according to the first embodiment of the present invention.

FIG. 4 is a flow chart of processes of the method for fabricating spacers according to the second embodiment of the present invention.

FIGS. 5A and 5B are the flow charts of the processes of the method for fabricating spacers according to the second embodiment of the present invention.

FIG. 6 is a cross-sectional view of a part of the SUS pipe of the spacer distributing apparatus as shown in FIG. 5A.

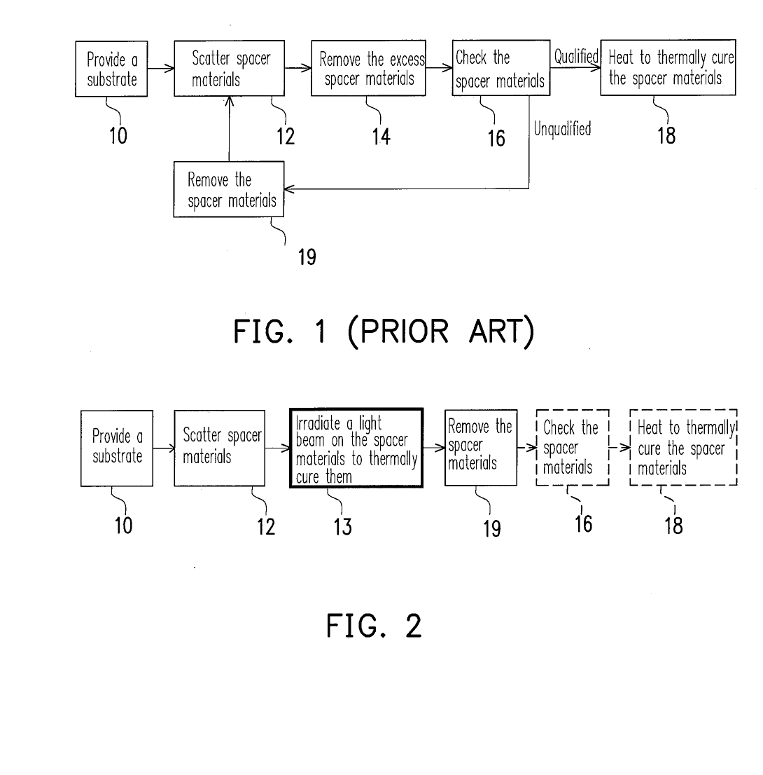

### DESCRIPTION OF EMBODIMENTS

In view of the disadvantages existing in the prior art, in the present invention, the spacer materials are made of, for example, thermosetting material or photocurable material. The spacer material is adhered to a specific region of the substrate, or the material when being sprayed is disposed in the specific region of the substrate. The aforementioned two methods will be described by the first and second embodiments.

### THE FIRST EMBODIMENT

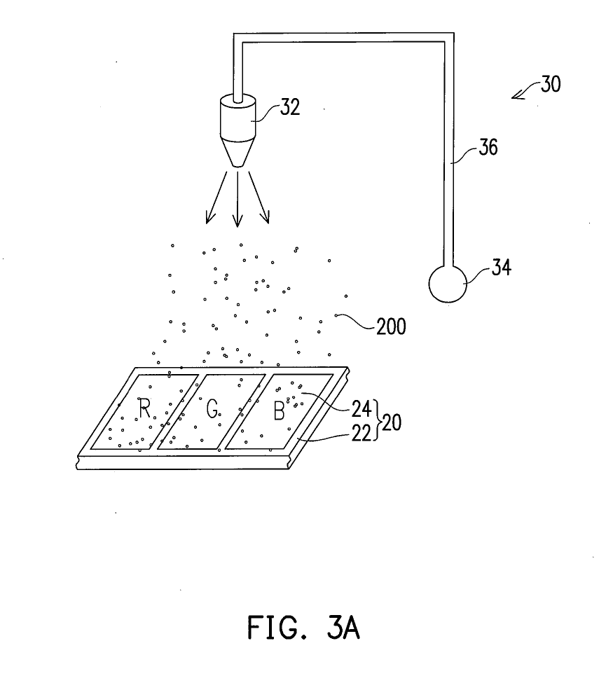

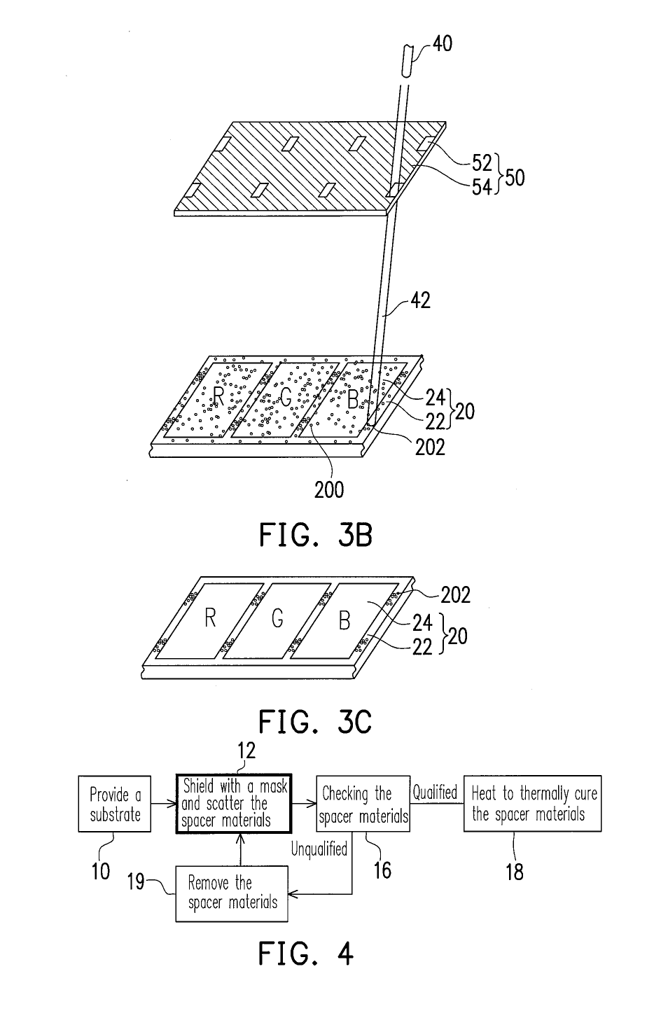

FIG. 2 is a flow chart of the processes of the method for fabricating spacers according to the first embodiment of the present invention. FIGS. 3A-3C are flow charts of the processes of the fabricating method. Furthermore, FIGS. 3A-3C only show one pixel, which are not depicted in scale.

Referring to FIGS. 2 and 3A, the spacers fabricated by the fabricating method provided by the present invention are suitable to be installed in an LCD panel. The LCD panel mainly includes an active device array substrate, a color filter substrate, and a liquid crystal layer disposed therebetween. The fabricating method includes the following steps. Firstly, in Step 10, a substrate 20 is provided. The substrate 20 can be an active device array substrate or a color filter substrate, and is divided into a display area and a non-display area. If the substrate 20 is an active device array substrate, the display area is a pixel electrode and the non-display area is the part of the substrate 20 excluding the pixel electrode. In this embodiment, the substrate 20 is, for example, a color filter substrate. The substrate 20 includes a black matrix 22 and a color filter film 24, and the color filter film 24 includes a red filter pattern R, a green filter pattern G, and a blue filter pattern B. The black matrix 22 is the non-display area of the substrate 20, and the color filter film 24 is the display area of the substrate 20.

Then, in Step 12, spacer materials are sprayed. The Step 12 can be performed by a spacer distributing apparatus 30 which is used to sprinkle ball type spacer materials, and the spacer materials 200 can be thermosetting materials or photocurable materials. The spacer distributing apparatus 30 includes a nozzle 32, a spacer material feeder 34, and an SUS pipe 36 connecting the nozzle 32 and the spacer material feeder 34. For example, in Step 12, the spacer materials 200 are drawn out from the spacer material feeder 34, delivered in the SUS pipe 36 by high-pressure nitrogen, and then sprayed over the substrate 20 through the nozzle 32.

Then, in Step 13, a light beam is irradiated to bake the spacer materials. As shown in FIG. 3B, the light beam 42 emitted from a light source 40 irradiates the spacer materials 200 on a part of the substrate 20, so as to bake the irradiated spacer materials 200, thereby forming the spacers 202. When the spacer materials 200 are photocurable materials, Step 13 can be a photochemical reaction instead of an endothermic chemical reaction. It is the non-display area that is irradiated by the light beam 42, such as a part of the surface of the black matrix 22. Furthermore, the light beam 42 irradiates a part of the spacer materials 200 through a mask 50, as shown in FIG. 3B. The material of the mask 50 is a heat-resistant metal that cannot be easily deformed. The mask 50 has a light transmissive area 52 and an opaque area 54, and the opaque area 54 shields the display area, i.e., shields the color filter film 24. Furthermore, the mask 50 can further shield a part of the non-display area, i.e., a part of the black matrix 22. The light beam 42 irradiates the spacer materials 200 on a part of the substrate 20 through the light-transmitting area 52 of the mask 50. On the other hand, if the position to be irradiated by the light beam 42 can be precisely controlled, the mask 50 can be removed, so as to directly irradiate and bake the spacer materials 200 at specific positions.

In detail, in Step 13, the light beam 42 can be UV light, infrared ray, or laser beam. Furthermore, the temperature of the light beam 42 irradiating and baking the spacer materials 200 on a part of the substrate 20 is in the range of about 120° C.-180° C., and preferably in the range of about 140° C.-160° C.

Subsequently, referring to FIGS. 2 and 3C, in Step 19, the spacer materials 200 are removed. For example, in Step 19, the spacer materials 200 which are not baked are removed by an ultrasonic cleaner (USC) (not shown), and the spacers 202 that have been baked are remained. Thus, the process of the spacers 202 is completed.

It should be noted that the conventional method for fabricating spacers includes performing Steps 10, 12, 16, and 18 in sequence. In Step 16, the distribution of the spacer materials 200 is checked, and in Step 18 the spacer materials 200 is baked. If in Step 16, the problem of cohesion, non-uniform distribution, or impurity of the spacer materials 200 is found, proceed to Step 19 to remove all the spacer materials 200. Then, repeat Steps 10, 12, 16, and 18. Compared with the conventional method, the method for fabricating spacers provided by the present invention can omit Steps 16 and 18, as the position where the spacer materials are dropped is determined. In this manner, the manufacturing cost is reduced.

### THE SECOND EMBODIMENT

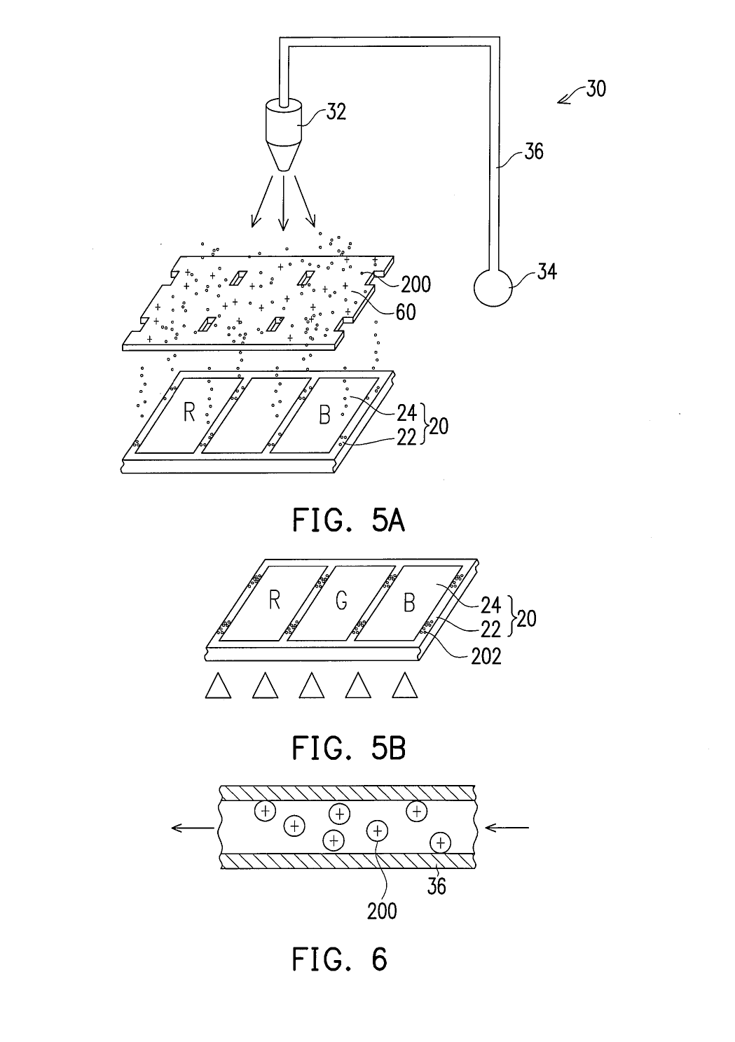

FIG. 4 is a flow chart of the processes of the method for fabricating spacers according to the second embodiment of the present invention. FIGS. 5A-5B are flow charts of the processes of the fabricating method. FIGS. 5A and 5B only show one pixel unit, which are not depicted in scale. FIG. 6 is a cross-sectional view of a part of the SUS pipe 36 of the spacer distributing apparatus 30 as shown in FIG. 5A. Furthermore, in the following descriptions, those that have been described in the first embodiment will not be repeated.

Referring to FIGS. 4, 5A, and 6, firstly, in Step 10, a substrate 20 is provided. Then, in Step 12, the spacer materials 200 are sprayed. The Step 12 can also be performed by the spacer distributing apparatus 30. However, a mask 60 is disposed between the nozzle 32 and the substrate 20. The material of the mask 60 can be a conductive metal that cannot be easily deformed. The spacer materials 200 are sprayed over a part of the substrate 20 through the mask 60. In this embodiment, the spacer materials 200 before being sprayed from the nozzle 32 rub the wall of the SUS pipe 36, thus carrying positive electric charges, so the mask 60 also carries positive electric charges. Therefore, the spacer materials 200 are repulsed with the pattern of the mask 60, and dropped at predetermined positions on the substrate 20. However, the present invention is not limited to this. In another embodiment, the spacer materials 200 rub the wall of the SUS pipe 36, thus carrying negative electric charges. Under this circumstance, the mask 60 must carry negative electric charges, so as to ensure that the spacer materials 200 are dropped at the predetermined positions on the substrate 20. Definitely, the mask 60 and the spacer materials 200 can have neither positive nor negative electric charges, and directly control the position where the spacer materials 200 are dropped by shielding a part of the region. The mask 60 can shield the display area (the color filter film 24). In this embodiment, the mask 60 further shields a part of the non-display area (the black matrix 22).

Then, referring to FIGS. 4 and 5B, in Step 16, the distribution of the spacer materials 200 is checked. If the distribution of spacer materials 200 is unqualified, i.e., the problem of cohesion, non-uniform distribution, or impurity occurs, proceed to Step 19 to remove the spacer materials 200. Then, repeat Steps 12 and 16 till it is confirmed that the distribution of the spacer materials 200 is qualified. If it is confirmed that the distribution of the spacer materials 200 is qualified, proceed to Step 18 to bake the spacer materials 200, thereby forming the spacers 202. For example, the temperature of baking the spacer materials 200 is in the range of about 120° C.-180° C., and preferably the range of about 140° C.-160° C.

The method for manufacturing spacers provided by the present invention includes in Step 12, disposing the mask 60 between the nozzle 32 and the substrate 20, thereby limiting the position on the substrate 20 where the spacer materials 200 are dropped. The mask 60 can be disposed by the use of the original processes or equipments, so the method for manufacturing the spacers may solve the problems of cohesion, light leakage, and bright spots caused by the spacers on the display area (such as the color filter film 24) with a low cost.

In view of the above, according to the present invention, since the positions where the spacers are formed are limited in the non-display area, the disadvantages of the ball type spacers are solved. In other words, according to the present invention, the cohesion of the spacers on the display area is alleviated, or the light leakage on the display area caused by the spacers is avoided. Furthermore, since the spacers are fabricated by baking the spacer materials, the spacers stick onto the substrate, and thereby the spacers will not move and scrape the substrate. In addition, compared with the process of fabricating the photo spacers, since the lithographic process is omitted, the method for fabricating spacers provided by the present invention has low cost. On the other hand, since the compression ratio and recovery ratio of the spacers made through the fabricating method provided by the present invention are superior to the photo spacers, the filling amount of the liquid crystal in the following processes can be easily controlled.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A method for fabricating spacers which are suitable to be installed in an LCD panel, the method for fabricating spacers comprising:
providing a substrate having a display area and a non-display area;
spraying a number of spacer materials over the substrate;
employing a light beam to irradiate the spacer materials through a mask shielding the display area in order to bake the spacer materials; and
removing the spacer materials which are not baked.

2. The method for fabricating spacers as claimed in claim 1, wherein the mask shields a part of the non-display area.

3. The method for fabricating spacers as claimed in claim 1, wherein the light beam comprises UV light, infrared ray, or laser beam.

4. The method for fabricating spacers as claimed in claim 1, wherein the position irradiated by the light beam is precisely controlled to remove the mask.

5. The method for fabricating spacers as claimed in claim 1, wherein a temperature of baking the spacer materials on a part of the substrate is in the range of 120° C.-180° C.

6. The method for fabricating spacers as claimed in claim 1, wherein a temperature of baking the spacer materials on a part of the substrate is in the range of 140° C.-160° C.

7. A method for fabricating spacers which are suitable to be installed in an LCD panel, the method for fabricating spacers comprising:
providing a substrate having a display area and a non-display area;
spraying a number of spacer materials over a part of the substrate through a mask; and
baking the spacer materials.

8. The method for fabricating spacers as claimed in claim 7, wherein all of the mask and the spacer materials carry positive electric charges or negative electric charges.

9. The method for fabricating spacers as claimed in claim 7, wherein the mask shields the display area.

10. The method for fabricating spacers as claimed in claim 9, wherein the mask shields a part of the non-display area.

11. The method for fabricating spacers as claimed in claim 7, wherein a temperature of baking the spacer materials is in the range of 120° C.-180° C.

12. The method for fabricating spacers as claimed in claim 7, wherein a temperature of baking the spacer materials is in the range of 140° C.-160° C.
